(19) United States
(12) Patent Application Publication
(10) Pub. No.: US 2006/0192758 A1
(43) Pub. Date: Aug. 31, 2006

(54) Wireless mouse-based method for remote control

(76) Inventor: Ho-Lung Lu, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/244,225

(22) Filed: Oct. 6, 2005

(30) Foreign Application Priority Data
Feb. 25, 2005 (TW) 94105928

(51) Int. Cl. G09G 5/08

(52) U.S. Cl. 345/163

(57) ABSTRACT

The present invention describes a wireless mouse-based method for remote control. The method detects whether the wireless mouse receives a signal indicative of the wireless mouse being away from a mask plane. A touch panel of the wireless mouse is activated. One type of wireless mouse-based remote control is chosen. The function of the chosen type of wireless mouse-based remote control is executed.

### BACKGROUND OF THE INVENTION

1. Field of the Invention

The present invention relates to a wireless mouse-based method for remote control, and in particular to a method for remote control by way of a wireless mouse, firmware and a communication protocol.

2. Description of Related Art

With the development of electronic appliance, many computer's peripheral or consumers' product do not need connection cables any more. For example, cordless telephones, mobile phones and wireless keyboard are prevalent. To develop these electronic product are to avoid the limitation of length of connection cable. For at least some users, the existence of the cable has limited the usefulness of existing electronic appliances. As to wireless mouse, even though there are successive development on firmware of the wireless mouse, function thereof is limited.

### SUMMARY OF THE INVENTION

It is an object of the present invention to provide a wireless mouse-based method for remote control. According to the present invention, a wireless mouse-based method for remote control utilizes firmware and a transmission protocol. Furthermore, more functions are implemented in the conventional wireless mouse so as to be more comfortable for everyday life.

In order to accomplish the object of the present invention, the present invention provides a wireless mouse-based method for remote control. The method comprises detecting whether the wireless mouse receives a signal indicative of the wireless mouse away from a mask plane; activating a touch panel of the wireless mouse; choosing one type of wireless mouse-based remote control; and executing the function of the chosen type of wireless mouse-based remote control.

### BRIEF DESCRIPTION OF THE DRAWINGS

The present invention can be fully understood from the following detailed description and preferred embodiment with reference to the accompanying drawings, in which:

FIG. 1 is a flowchart illustrating the wireless mouse-based method for remote control according to the present invention;

FIG. 2 is a flowchart illustrating how the wireless mouse remotely controls multimedia device according to the present invention;

FIG. 3 is a flowchart illustrating how the wireless mouse remotely controls file systems of a host computer according to the present invention; and

FIG. 4 is a flowchart illustrating how the wireless mouse remotely controls an electronic whiteboard of the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

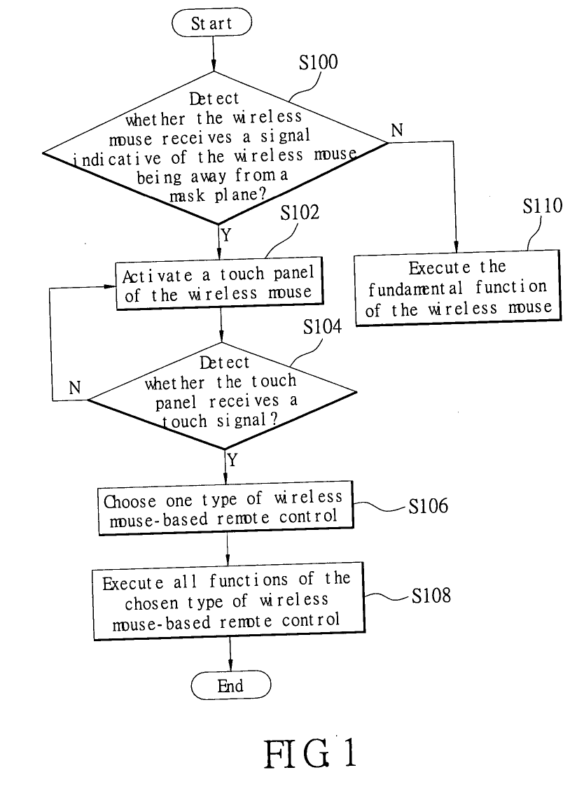

Reference is made to FIG. 1. FIG. 1 is a flowchart illustrating a wireless mouse-based method for remote control according to the present invention. The process of the flowchart is described in detail below.

Step S100:

In step S100, firmware installed in the wireless mouse detects whether the wireless mouse receives a signal indicative of the wireless mouse away from a mask plane. After the wireless mouse is turned on, the firmware installed in the wireless mouse automatically detects whether the wireless mouse is away from the mask plane. Besides, the wireless mouse can be placed on the mask plane, and the signal can be a radio frequency (RF) signal or a bluetooth signal. If the wireless mouse receives the signal, then the process continues to step S102. Otherwise, the process jumps to step S110.

Step S102:

In step S102, the firmware is used to activate a touch panel of the wireless mouse. Besides, the fundamental function of the wireless mouse is deactivated by the firmware. Then, the process continues to step S104.

Step S104:

In step S104, the firmware of the wireless mouse detects whether the touch panel receives a touch signal. The touch signal is generated by the touch panel or obtained by striking a key of the touch panel. If the touch panel receives the touch signal, then the process continues to step S106. Otherwise, the process returns to step S102.

Step S106:

In step S106, the firmware of the wireless mouse chooses one type of wireless mouse-based remote control. Then, the process continues to step S108.

Step S108:

In step S108, the firmware of the wireless mouse executes the function of the chosen type of wireless mouse-based remote control.

Step S110:

In step S110, the firmware executes the fundamental function of the wireless mouse.

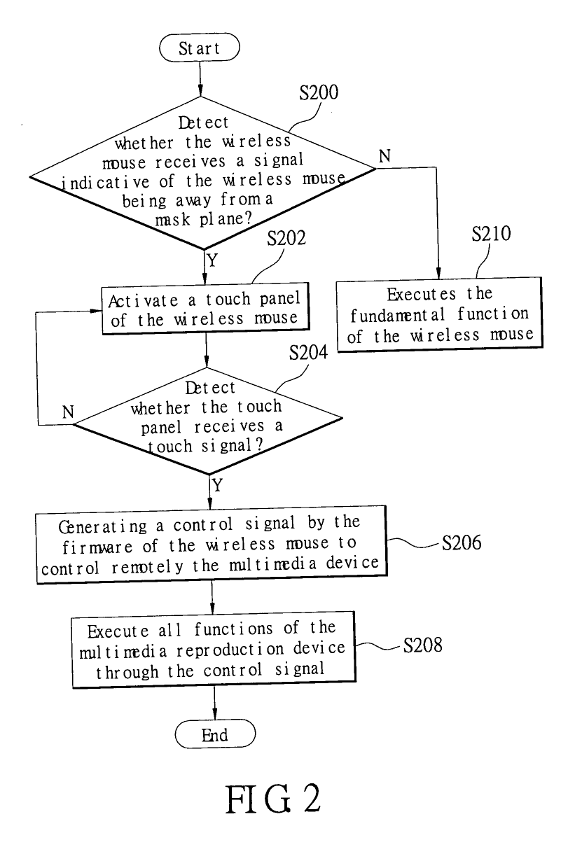

Reference is made to FIG. 2. FIG. 2 illustrates how the wireless mouse remotely controls multimedia device according to the present invention. The process of the flowchart is described in detail below.

Step S200:

In step S200, firmware installed in the wireless mouse detects whether the wireless mouse receives a signal indicative of the wireless mouse away from a mask plane. After the wireless mouse is turned on, the firmware installed in the wireless mouse automatically detects whether the wireless mouse is away from the mask plane. Besides, the wireless mouse can be placed on the mask plane, and the signal can be a radio frequency (RF) signal or a bluetooth signal. If the wireless mouse receives the signal, then the process continues to step S202. Otherwise, the process goes to step S210.

Step S202:

In step S202, the firmware is used to activate a touch panel of the wireless mouse. Besides, the fundamental function of the wireless mouse is deactivated by the firmware. Then, the process continues to step S204.

Step S204:

In step S204, the firmware of the wireless mouse detects whether the touch panel receives a touch signal. The touch signal is generated by the touch panel or obtained by striking a key of the touch panel. If the touch panel receives the touch signal, then the process continues to step S206. Otherwise, the process returns to step S202.

Step S206:

In step S206, responsive to the touch signal, a control signal is generated by the firmware of the wireless mouse. The control signal is used to control remotely a multimedia device. The multimedia device can be a multimedia reproduction device. Then, the process continues to step S208.

Step S208:

In step S208, the firmware of the wireless mouse executes all functions of the multimedia reproduction device through the control signal. For example, some functions of the multimedia reproduction device are “play”, “stop”, “fast forward”, “forward”, and “reverse”.

Step S210: In step S210, the firmware executes the fundamental function of the wireless mouse.

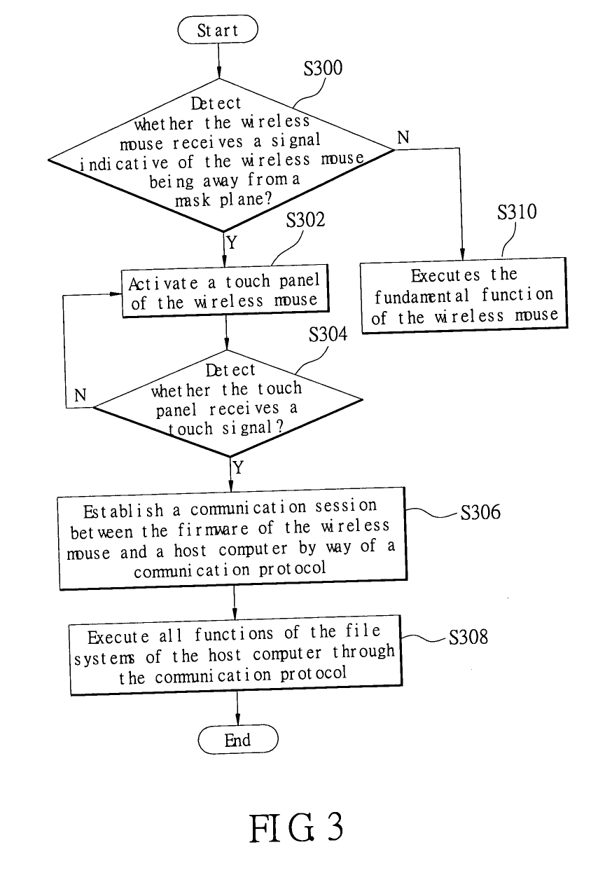

Reference is made to FIG. 3. FIG. 3 is a flowchart illustrating how the wireless mouse remotely controls file systems of a host computer according to the present invention. The process of the flowchart is described in detail below.

Step S300:

In step S300, firmware installed in the wireless mouse detects whether the wireless mouse receives a signal indicative of the wireless mouse away from a mask plane. After the wireless mouse is turned on, the firmware installed in the wireless mouse automatically detects whether the wireless mouse is away from the mask plane. Besides, the wireless mouse can be placed on the mask plane, and the signal can be a radio frequency (RF) signal or a bluetooth signal. If the wireless mouse receives the signal, then the process continues to step S302. Otherwise, the process goes to step S310.

Step S302:

In step S302, the firmware is used to activate a touch panel of the wireless mouse. Besides, the fundamental function of the wireless mouse is deactivated by the firmware. Then, the process continues to step S304.

Step S304:

In step S304, the firmware of the wireless mouse detects whether the touch panel receives a touch signal. The touch signal is generated by the touch panel or obtained by striking a key of the touch panel. If the touch panel receives the touch signal, then the process continues to step S306. Otherwise, the process returns to step S302.

Step S306: In step S306, responsive to the touch signal, a communication session is established between the firmware of the wireless mouse and a host computer by way of a communication protocol. Then, the process continues to step S308.

Step S308:

In step S308, the firmware of the wireless mouse executes all functions of the file systems of the host computer through the communication protocol. For example, some functions are “open file”, “save”, “rename”, and “close file”.

Step S310:

In step S310, the firmware executes the fundamental function of the wireless mouse.

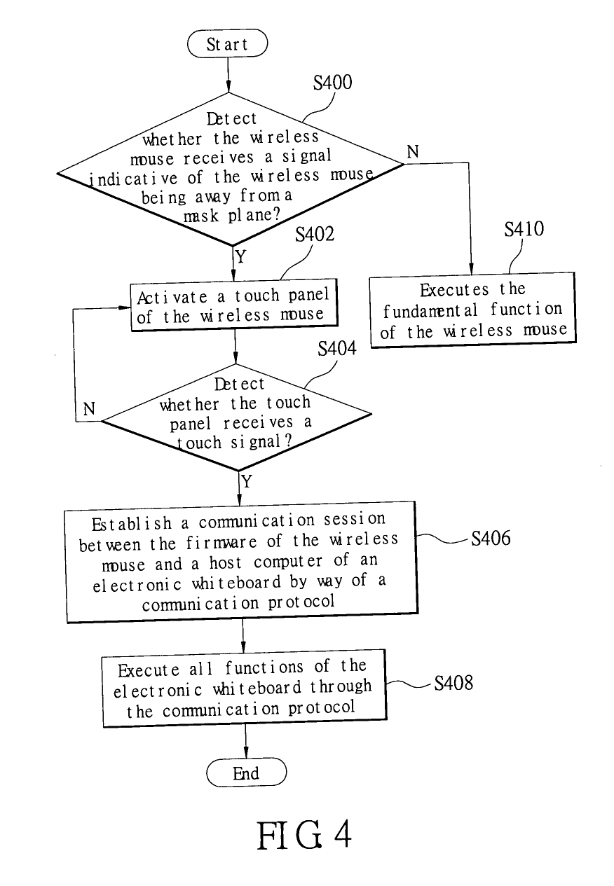

Reference is made to FIG. 4. FIG. 4 is a flowchart illustrating how the wireless mouse remotely controls an electronic whiteboard of the present invention. The process of the flowchart is described in detail below.

Step S400:

In step S400, firmware installed in the wireless mouse detects whether the wireless mouse receives a signal indicative of the wireless mouse away from a mask plane. After the wireless mouse is turned on, the firmware installed in the wireless mouse automatically detects whether the wireless mouse is away from the mask plane. Besides, the wireless mouse can be placed on the mask plane, and the signal can be a radio frequency (RF) signal or a bluetooth signal. If the wireless mouse receives the signal, then the process continues to step S402. Otherwise, the process goes to step S410.

Step S402:

In step S402, the firmware is used to activate a touch panel of the wireless mouse. Besides, the fundamental function of the wireless mouse is deactivated by the firmware. Then, the process continues to step S404.

Step S404:

In step S404, the firmware of the wireless mouse detects whether the touch panel receives a touch signal. The touch signal is generated by the touch panel or obtained by striking a key of the touch panel. If the touch panel receives the touch signal, then the process continues to step S406. Otherwise, the process returns to step S402.

Step S406:

In step S406, responsive to the touch signal, a communication session is established between the firmware of the wireless mouse and a host computer of an electronic whiteboard by way of a communication protocol. Then, the process continues to step S408.

Step S408:

In step S408, the firmware of the wireless mouse executes all functions of the electronic whiteboard through the communication protocol.

Step S410:

In step S410, the firmware executes the fundamental function of the wireless mouse.

According to the embodiments of the present invention, the functions of the wireless mouse are upgraded so that the wireless mouse not only has all functions of the conventional wireless mouse but also has capability of remote control by way of firmware. The wireless mouse can remotely control a multimedia device, file systems of host computer, and an electronic whiteboard.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

What is claimed is:

1. A wireless mouse-based method for remote control, the steps comprising:
detecting whether the wireless mouse receives a signal indicative of the wireless mouse being away from a mask plane;
activating a touch panel of the wireless mouse;
detecting whether the touch panel receives a touch signal;
choosing one type of wireless mouse-based remote control; and
executing all functions of a chosen type of wireless mouse-based remote control.

2. The method for remote control as claimed in claim 1, wherein the signal indicative of the wireless mouse being away from a mask plane is a radio frequency (RF) signal or a bluetooth signal.

3. The method for remote control as claimed in claim 1, wherein if the wireless mouse receives the signal, then the firmware is used to activate a touch panel of the wireless mouse, and if the wireless mouse does not receive the signal, then the firmware executes the fundamental function of the wireless mouse.

4. The method for remote control as claimed in claim 1, wherein if the touch panel receives the touch signal, then the firmware of the wireless mouse chooses one type of wireless mouse-based remote control, and if the touch panel does not receive the touch signal, then the firmware is used to activate a touch panel of the wireless mouse.

5. The method for remote control as claimed in claim 1, wherein the touch signal is obtained by striking a key of the touch panel.

6. The method for remote control as claimed in claim 1, wherein the touch signal is generated by the touch panel.

7. A wireless mouse-based method for remotely controlling a multimedia device, the steps comprising:
detecting whether the wireless mouse receives a signal indicative of the wireless mouse being away from a mask plane;
activating a touch panel of the wireless mouse;
detecting whether the touch panel receives a touch signal;
generating a control signal by the firmware of the wireless mouse to control remotely the multimedia device; and
executing all functions of the multimedia reproduction device through the control signal.

8. The method for remotely controlling a multimedia device as claimed in claim 7, wherein the signal indicative of the wireless mouse being away from a mask plane is a radio frequency (RF) signal or a bluetooth signal.

9. The method for remotely controlling a multimedia device as claimed in claim 7, wherein if the wireless mouse receives the signal, then the firmware is used to activate a touch panel of the wireless mouse, and if the wireless mouse does not receive the signal, then the firmware executes the fundamental function of the wireless mouse.

10. The method for remotely controlling a multimedia device as claimed in claim 7, wherein if the touch panel receives a touch signal, then a control signal is generated by the firmware of the wireless mouse and used to control remotely the multimedia device, and if the touch panel does not receive a touch signal, then the firmware is used to activate a touch panel of the wireless mouse.

11. The method for remotely controlling a multimedia device as claimed in claim 7, wherein the touch signal is obtained by striking a key of the touch panel.

12. The method for remotely controlling a multimedia device as claimed in claim 7, wherein the touch signal is generated by the touch panel.

13. A wireless mouse-based method for remotely controlling file systems of a host computer, the steps comprising:
detecting whether the wireless mouse receives a signal indicative of the wireless mouse being away from a mask plane;
activating a touch panel of the wireless mouse;
detecting whether the touch panel receives a touch signal;
establishing a communication session between the firmware of the wireless mouse and a host computer by way of a communication protocol; and
executing all functions of the file systems of the host computer through the communication protocol.

14. The method for remotely controlling file systems of the host computer as claimed in claim 13, wherein the signal indicative of the wireless mouse being away from a mask plane is a radio frequency (RF) signal or a bluetooth signal.

15. The method for remotely controlling file systems of the host computer as claimed in claim 13, wherein if the wireless mouse receives the signal, then the firmware is used to activate a touch panel of the wireless mouse, and if the wireless mouse does not receive the signal, then the firmware executes the fundamental function of the wireless mouse.

16. The method for remotely controlling file systems of the host computer as claimed in claim 13, wherein if the touch panel receives a touch signal, then a communication session is established between the firmware of the wireless mouse and a host computer by way of a communication protocol, and if the touch panel does not receive a touch signal, then the firmware is used to activate a touch panel of the wireless mouse.

17. The method for remotely controlling file systems of the host computer as claimed in claim 13, wherein the touch signal is obtained by striking a key of the touch panel.

18. The method for remotely controlling file systems of the host computer as claimed in claim 13, wherein the touch signal is generated by the touch panel.

19. A wireless mouse-based method for remotely controlling an electronic whiteboard, the steps comprising:
detecting whether the wireless mouse receives a signal indicative of the wireless mouse being away from a mask plane;
activating a touch panel of the wireless mouse;
detecting whether the touch panel receives a touch signal;
establishing a communication session between the firmware of the wireless mouse and a host computer by way of a communication protocol; and
executing all functions of the electronic whiteboard of the host computer through the communication protocol.

20. The method for remotely controlling the electronic whiteboard as claimed in claim 19, wherein the signal indicative of the wireless mouse being away from a mask plane is a radio frequency (RF) signal or a bluetooth signal.

21. The method for remotely controlling the electronic whiteboard as claimed in claim 19, wherein if the wireless mouse receives the signal, then the firmware is used to activate a touch panel of the wireless mouse, and if the wireless mouse does not receive the signal, then the firmware executes the fundamental function of the wireless mouse.

22. The method for remotely controlling the electronic whiteboard as claimed in claim 19, wherein if the touch panel receives a touch signal, then a communication session is established between the firmware of the wireless mouse and the electronic whiteboard by way of a communication protocol, and if the touch panel does not receive a touch signal, then the firmware is used to activate a touch panel of the wireless mouse.

23. The method for remotely controlling the electronic whiteboard as claimed in claim 19, wherein the touch signal is obtained by striking a key of the touch panel.

24. The method for remotely controlling the electronic whiteboard as claimed in claim 19, wherein the touch signal is generated by the touch panel.
